(19) United States
(12) Patent Application Publication
(10) Pub. No.: US 2011/0124350 A1
(43) Pub. Date: May 26, 2011

(54) POINT TO CONNECT COMMUNICATION INTERFACE

(76) Inventor: Predrag Sukovic, Ann Arbor, MI (US)

(21) Appl. No.: 12/875,234

(22) Filed: Sep. 3, 2010

Related U.S. Application Data
(60) Provisional application No. 61/262,940, filed on Nov. 20, 2009.

(51) Int. Cl. H04W 4/02

(52) U.S. Cl. 455/456.3

(57) ABSTRACT

In one embodiment, the system for a point to connect communication interface comprises a desired receiving device, operable to receive information desired to be sent; a mobile device, operable to transmit the information desired to be sent, a GPS location of the mobile device and a direction from the mobile device to the desired receiving device, a server, operable to receive the information desired to be sent, the GPS location of the mobile device and the direction from the mobile device to the desired receiving device, locate the desired receiving device from among candidate devices, and transmit the information desired to be sent to the desired receiving device. The desired receiving device may be another mobile device, or for example another device such as a printer or television. The information desired to be sent may be a business card, or another type of information such as a document or spreadsheet, digital media file such as a song or a command to the desired receiving device.

This application claims priority to U.S. Provisional Application Ser. No. 61/262,940, filed Nov. 20, 2009.

### BACKGROUND OF THE INVENTION

The present invention provides a system for a point to connect communication interface.

Oftentimes, it is desirable to transmit information quickly directly between two devices, such as mobile devices. In this age of disappearing paper, the user may want to send an electronic business card to another user. The user would preferably want a fast method to send such a card, and hope to avoid tedious steps along the way, such as selecting the other user's device on a short range wireless network. Furthermore, with the prevalence of computer viruses and other privacy concerns, it is less desirable to connect directly with another unfamiliar electronic device.

As electronic systems are more and more being bundled together, it is becoming desirable to possess devices with multiple functionalities. One area in particular that embraces this idea is that of mobile devices. Many current mobile devices not only possess telephone capabilities, but also allow the user to browse the internet and send emails, listen to music, play video games and navigate via GPS. In light of this trend, it can be beneficial to the user to imbed further functionality into mobile devices, such as the ability to easily print files or control household electronics and appliances.

There are methods known in the art for communication between devices. Infrared ports have long been used for this purpose. Unfortunately, infrared communications have many drawbacks, such as the need to maintain line of sight between the devices, and have them within the infrared effective range. Recently, device to device wireless communications, such as those using the Bluetooth standard, have become more prominent. These methods too have their drawbacks, such as directly connecting the devices and allowing the transmission of viruses or other security threats.

### SUMMARY OF THE INVENTION

Generally, the invention provides the ability to have information sent to another person or device without a direct connection. The information may be commands, payment, a digital document, a media file, etc. The invention may provide the ability to send payment to a device for the purpose of purchasing items, such as a vending machine or an unattended store.

In one embodiment, the system for a point to connect communication interface includes a desired receiving device, operable to receive information desired to be sent; a mobile device, operable to transmit the information desired to be sent, a GPS location of the mobile device and a direction from the mobile device to the desired receiving device, a server, operable to receive the information desired to be sent, the GPS location of the mobile device and the direction from the mobile device to the desired receiving device, locate the desired receiving device from among candidate devices, and transmit the information desired to be sent to the desired receiving device. The desired receiving device may be another mobile device, or for example another device such as a printer or television. The information desired to be sent may be a business card, or another type of information such as a document or spreadsheet, digital media file such as a song or a command to the desired receiving device.

### BRIEF DESCRIPTION OF THE DRAWINGS

FIG. 1 schematically illustrates an example system for a point to connect communication interface.

FIG. 2 schematically illustrates an example mobile device of the present invention.

FIG. 3 schematically illustrates an example receiving device of the present invention receiving information.

FIG. 4 illustrates use of the invention with another embodiment of the receiving device.

FIG. 5 illustrates one way of calibrating the receiving device of FIG. 4.

FIG. 6 illustrates use of the invention with another embodiment of receiving devices.

FIG. 7 illustrates use of the invention with another embodiment of receiving devices.

### DETAILED DESCRIPTION OF THE PREFERRED EMBODIMENT

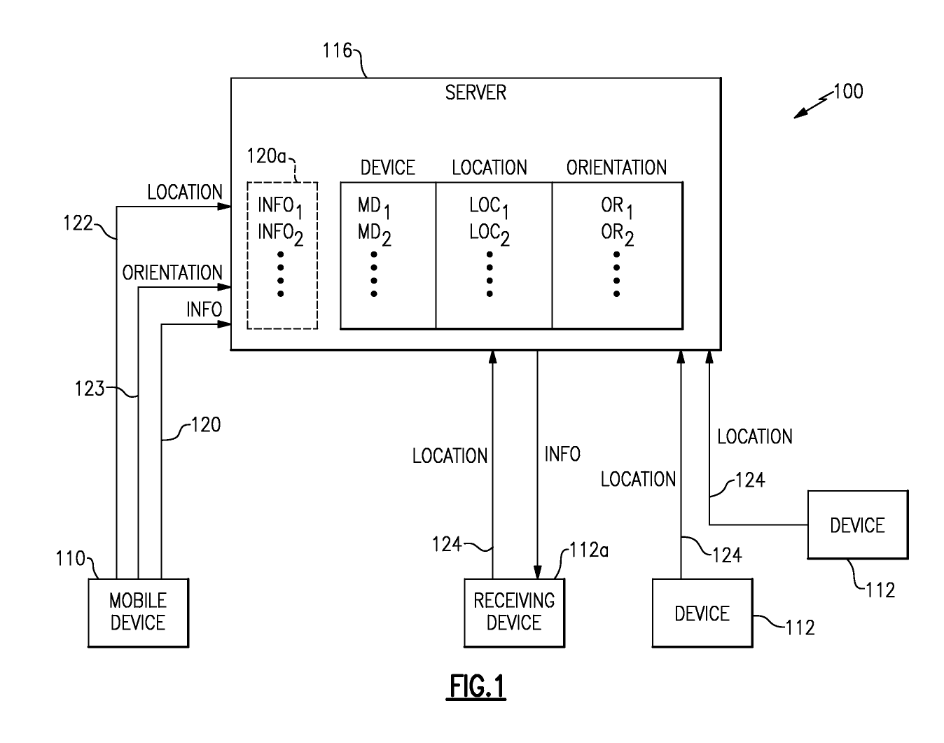

FIG. 1 is a schematic illustration of a system 100 for a point to connect communication interface according to one embodiment of the present invention. The system 100 includes a server 116 communicating with a mobile device 110 and a plurality of devices 112. In this example, the mobile device 110 is the device transmitting the information and one of the receiving devices 112a is the intended recipient of the information, but it is contemplated that at least some of the devices 112 would also be mobile devices capable of transmitting information to others of the devices 112 and to the mobile device 110 in the same manner described below.

The server 116 stores location and orientation information for each of the devices 112, 112a and the mobile device 110. For a device 112 that will never transmit information and is only intended to receive information, the orientation information is not necessary. The mobile device 110 sends updated location information 122 (e.g. from GPS) and orientation information 123 (such as from a compass and/or pitch sensor) to the server 116, either periodically, or when the mobile device 110 is sending information 120 to the server 116 that is intended to be relayed to one of the devices 112.

The devices 112 also send at least location information 124 to the server 116, and optionally, orientation information (if the devices 112 may also be transmitting devices). Optionally, for devices 112 that are stationary, the location information 124 of the devices may be simply stored on the server 116 manually or via some other method without need for regular updating.

When a user of the mobile device 110 desires to send information 120 to the desired receiving device 112a, the user points the mobile device 110 at the desired receiving device 112a and activates the information transmission. The information 120 may be sent to the server 116 from the mobile device 110, as is the current location 122 and current orientation 123 of the mobile device 110. Alternatively, the information exists on the server 116 and is indicated or selected by the mobile device 110 user interface. By comparing the current location 122 and current orientation 123 of the mobile device 110 to the locations of all of the other devices 112, the server 116 can determine that the mobile device 110 is pointing to the device 112a and therefore that the device 112a is the intended recipient of the information 120. If there is some ambiguity (or even if there is no ambiguity), the server 116 can ask the user via the mobile device 110 to confirm the identity of the intended recipient device 112a (e.g. “Do you really want to send information to [description of selected device]?”) and then transmit the information 120 to the intended recipient device 112a.

The server 116 may log the transmission of the information 120. The server 116 may charge a fee to an account associated with the mobile device 110 for the transmission of the information 120. The fee may depend upon the size or type of information 120 that was transmitted.

The mobile device 110 could be an Apple iPhone 3GS or iPhone 4 running version 3.0 or 4.02 of the iPhone software. The information 120 could be for example a digital business card, a document, a photo or a media file (song, video, movie, etc). The desired receiving device 112a could be another mobile device of another user. The desired receiving device 112a may be a printer, in which case the information 120 may be a file to be printed. In this manner, the system 100 can provide public access to printers without specialized software or printer drivers, which could be handled by the server 116.

The desired receiving device 112a could be a television or other electronic device, in which case the information 120 sent by the mobile device 110 may be commands to change the channel, change the inputs, turn it off or on, or adjust the volume or otherwise change the operation of the device 112a.

The information 120 may originate on the mobile device 110. Alternatively, the information 120a may be selected by the user from available information 120a stored on the server 116 for transmission to the desired receiving device 112. For example, the information 120a may be songs, videos, photos, movies or other files. The server 116 may charge a fee to the account associated with the mobile device 110 for the purchased (or rented) information 120a.

By using the server 116 as a buffer between the mobile device 110 and the desired receiving device 112, both devices are shielded from possible security threats, such as viruses, that could be transmitted via a direct connection between the devices. Compatibility of communication among odd devices 110, 112 is facilitated by the server 116 providing a uniform communication protocol and eliminating the need for various drivers.

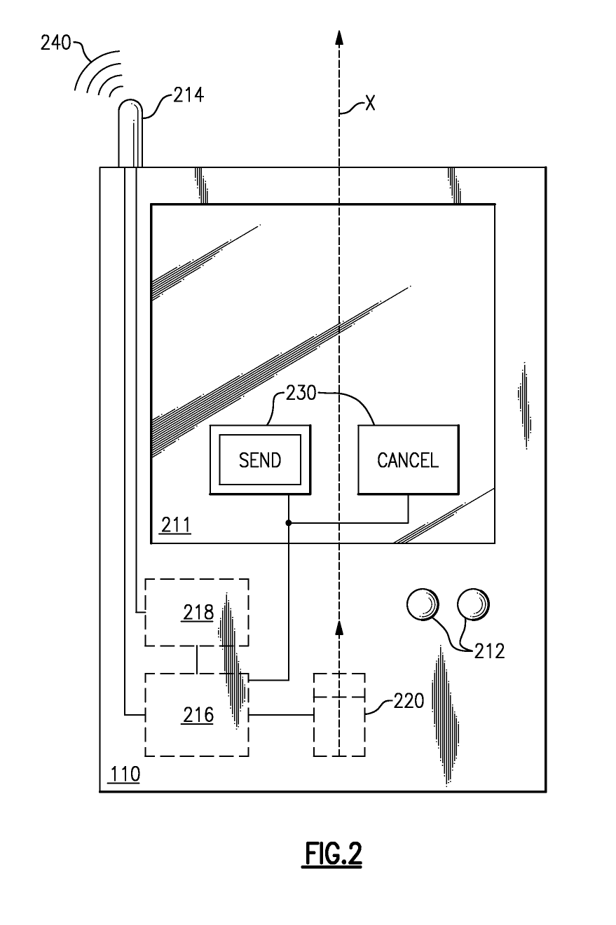

FIG. 2 is an example of one possible schematic of the mobile device 110 of FIG. 1. The mobile device 110 comprises a screen 211 (such as a touchscreen), input controls 212, a signal communications system 214, an internal computer 216 connected to the signal communications system 214, a GPS receiver 218 connected to the signal communications system 214 and internal computer 216, and a sensor system 220 connected to the internal computer 216.

The GPS receiver 218 determines the location of the mobile device 110 relative to Earth (or some other location sensor could determine the location of the mobile device 110 relative to some other reference frame). The sensor system 220 may include a compass and pitch sensor, or other types of directional sensor. The sensor system 220 determines the orientation of the mobile device 110 relative to some reference frame, such as Earth (or some other reference frame). Options 230 may be shown on the screen 211 for selecting information desired to be sent to the desired receiving device 112. An information bundle 240 may be sent from the mobile device 110 via the signal communications system 214, the information bundle comprising the information 120 and the location 122 and orientation 123 (FIG. 1) of the mobile device 110. The mobile device 110 could be an Apple iPhone 3GS or iPhone 4 running version 3.0 or 4.02 of the iPhone software. The desired direction, i.e. the direction the user is “pointing” the mobile device 110 may be defined in any manner that is clear to the user, for example, along a center longitudinal axis x of the mobile device 110, as illustrated. The server 116 (FIG. 1) determines the “pointing direction” x based upon the orientation of the mobile device 110 relative to the reference frame. Other directions could be defined, as long as it's clear to the user.

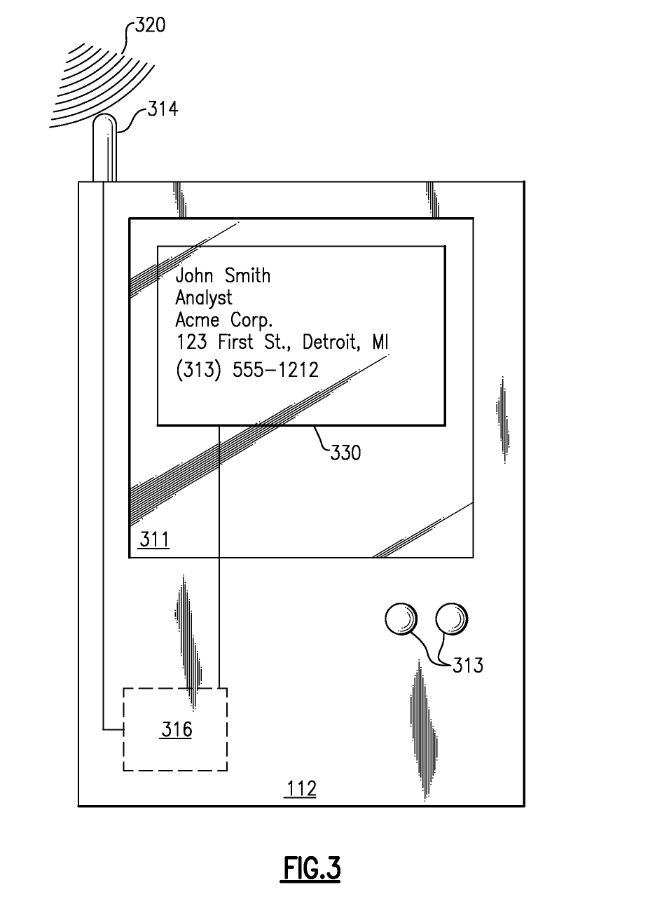

FIG. 3 is a schematic illustration of an example receiving device 112 of FIG. 1. The desired receiving device 112 may include a screen 311, input controls 313, a signal communication system 314, and an internal computer 316 connected to the signal communication system 314. The desired receiving device 112 could be an Apple iPhone 3GS or iPhone 4 running version 3.0 or 4.02 of the iPhone software.

The desired receiving device 112 receives information 320 via the signal communications system 314. The information 320 may be processed by the internal computer 316, and processed information 330 may be displayed on the screen 311. For example, the processed information 330 may be a digital business card sent to the user of the desired receiving device. Alternatively, the processed information may be a document or spreadsheet.

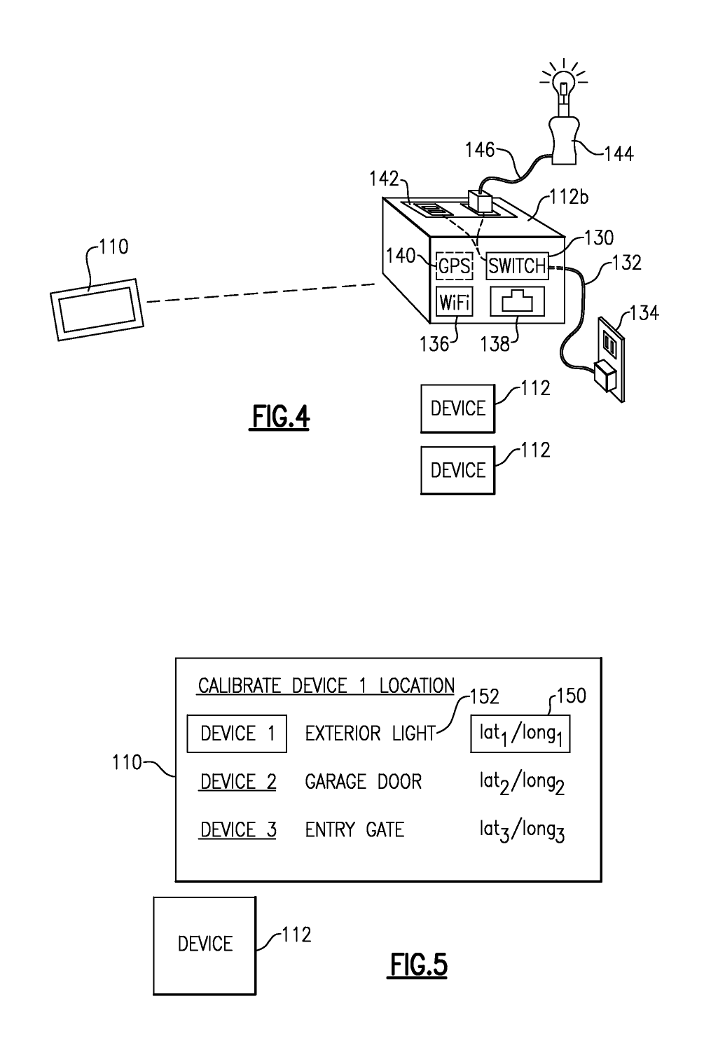

FIG. 4 illustrates use of the invention with another type of receiving device 112b. The receiving device 112b generally includes a switch 130 selectively providing power, such as from a standard power cord 132 plugged into a standard household electrical outlet 134. Alternatively, the switch 130 could be hard wired to electrical power or the housing of the device could include prongs protruding directly therefrom into the outlet 134. The switch 130 is operated by a processor or dedicated circuitry receiving a signal via a transceiver, such as a wifi transceiver 136 and/or a hard-wired network connection 138, such as an Ethernet jack. The receiving device 112b could optionally include a gps receiver 140 (or other locating hardware). When activated, the switch 130 provides electrical power to outlets 142, which may be connected to any electrical device 144, such as a light via a power cord 146. In FIG. 4, the receiving device 112b is not shown to scale, as it is contemplated that the device could be small enough to mount on the outlet 134 or on the electrical device 144.

With this embodiment, it is easy for anyone, including homeowners, to purchase the receiving device 112b and connect it to an electrical device 144 that can thereafter be controlled in the manner described above. In particular, this could be useful for difficult to access devices 144, such as exterior lights. The user can then switch the electrical device 144 on and off by pointing the mobile device 110 at the location of the receiving device 112b and sending a command to the server 116 (FIG. 1), such as by pressing a button on a touchscreen of the device. Optionally, commands other than simply on and off could be sent from the device 112b to the electrical device 144 via a low-voltage wire, optical coupling, Ethernet cable, USB cable, or the like, between the receiving device 112b and the electrical device 144.

If the receiving device 112b does not include its own gps receiver 140, the location of the receiving device 112b can be sent to the server 16 by the mobile device 110 in a calibration mode as shown in FIG. 5. The mobile device 110 can be placed on or adjacent the receiving device 112b. The location (e.g. lat/long) of the receiving device 112b is then taken as the location of the mobile device 110 and stored in field 150 on the server 16 (FIG. 1). Via the user interface on the mobile device 110 (and/or via a web browser), the user can also enter a descriptor of the receiving device 112b in field 152 for future reference. The receiving device 112b can later be moved and used to control different electrical devices 144 and recalibrated in the same way. Alternatively, the mobile device 110 can be placed on or adjacent the electrical device 144 itself, which may be a different location and/or orientation from the receiving device 112b, in which case the electrical device 144 is a “receiving device” or part of a “receiving device.” A single receiving device 112b could independently operate a plurality of electrical devices 144 in different locations/orientations, such that the user could point to any of the electrical devices 144 to control them.

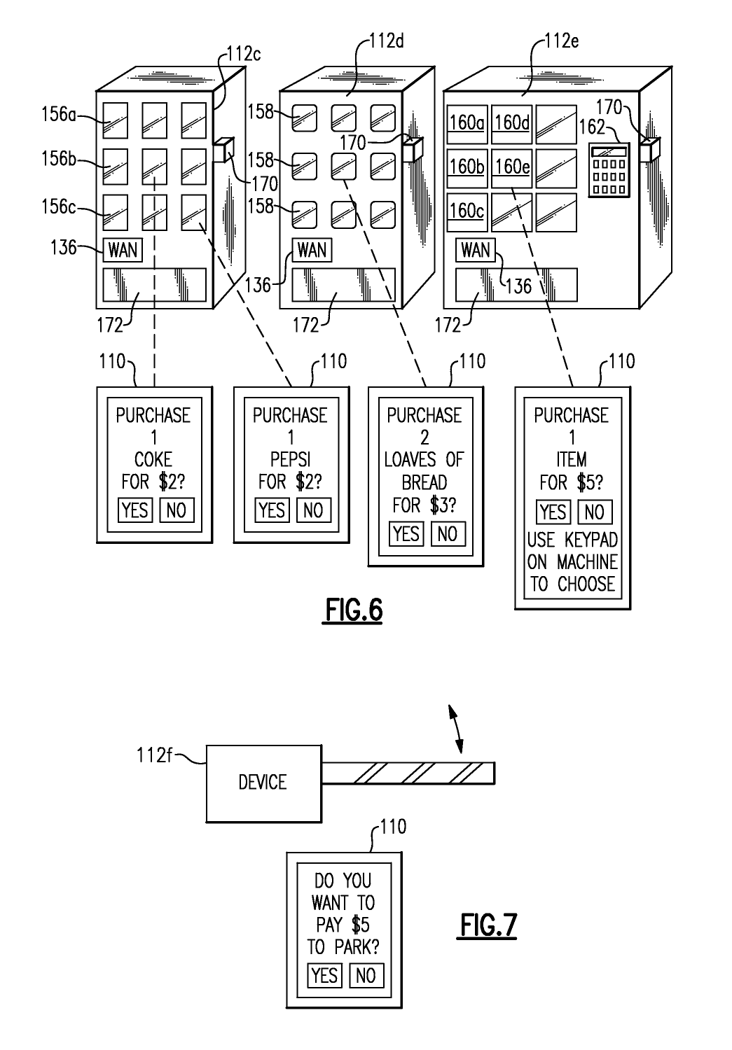

FIG. 6 illustrates another example use of the present invention. In this example, the receiving devices 112c, 112d, 112e are vending machines vending products 156, 158, 160, respectively. The receiving devices 112c-e, each include a dispensing mechanism 170 (such as a motor) for pushing or dropping the products 156, 158, 160 so that they can be retrieved by the purchaser via a door or opening 172. The receiving devices 112c-e also include wide area network (WAN) interfaces 136, such as wifi or Ethernet ports. The receiving devices 112c-e include programmed processors or dedicated circuitry for dispensing the products 156, 158, 160 based upon commands from the server 16 (FIG. 1) received over the WAN interfaces 172.

To purchase a product 156, the user points the mobile device 110 at the product 156. In the first receiving device 112c, the rows of products 156 contain different products, such that tilting the mobile device 110 a different amount will point to a different row and the user can choose to purchase a product 156 in that row. Once the server 16 receives the request, the server 16 identifies the receiving device 112c (and optionally, the row) based upon its location and based upon the location and orientation of the mobile device 110. The server sends a confirmation screen to the mobile device 110 which asks the user to confirm the purchase of the product 156. Upon confirmation, the server 16 debits the user's account and instructs the receiving device 112c to dispense the selected product.

Alternatively, all of the products 158 in the receiving device 112d may be the same. As shown, the user can purchase more than one of the products 158 at a time.

Alternatively, as shown in the receiving device 112e, even if the products 160a-n are different, if they are priced the same (or at least if some of them are priced the same), the user can choose to purchase one or more such items 160a-n. Upon authorization of the receiving device 112e by the server 16 (and debit of the user's account), the user selects the specific product 160 using a keypad or other input device 162 on the receiving device 112e. The receiving device 112e then dispenses the selected product to the user.

As shown in FIG. 7, the invention can also be used to provide payment where a product is not obtained in exchange, but for the purpose of obtaining access, such as to a parking lot. In this example, the receiving device 112f is configured in combination with a motorized gate.

Although preferred embodiments of this invention have been disclosed, a worker of ordinary skill in this art would recognize that certain modifications would come within the scope of this invention. For that reason, the following claims should be studied to determine the true scope and content of this invention.

1. A method for communicating, comprising the steps of:
storing a location of a mobile device and a pointing direction in which the mobile device is pointed;
determining a desired receiving device from among candidate devices based upon locations of the candidate devices and based upon the location and the pointing direction of the mobile device;
transmitting information as indicated by the mobile device to the desired receiving device; and
billing a user of the mobile device for the transmission of the information to the desired receiving device.

2. The method of claim 1 further including the step of receiving the information from the mobile device.

3. The method of claim 1 further comprising the step of forwarding a record of transmission between the mobile device and the desired receiving device to a communications service provider of the mobile device.

4. (canceled)

5. The method of claim 1 wherein the desired receiving device is another mobile device.

6. The method of claim 1 wherein the desired receiving device is a printer and wherein the information is to be printed.

7. The method of claim 1 wherein the desired receiving device is an appliance and the information is a command.

8. The method of claim 1 further including the step of selling the information to the user of the mobile device.

9. The method of claim 1 wherein the information is a business card.

10. (canceled)

11. The method of claim 1 wherein the information is a command.

12. The method of claim 1 wherein the information is the selection of a product to be purchased by the user and further including the step of sending a command to the desired receiving device to dispense the product.

13. A server for providing communication between a mobile device and a desired receiving device, wherein the server is programmed to receive a location of the mobile device and a pointing direction of the mobile device, wherein the server is programmed to identify the desired receiving device from among a plurality of candidate devices based upon the location and pointing direction of the mobile device and based upon respective locations of the plurality of candidate devices, and wherein the server is programmed to transmit information as indicated by the mobile device to the desired receiving device, wherein the server is further programmed to transmit a record of the transmission of the information as indicated by the mobile device to the desired receiving device to a communications service provider of the mobile device.

14. (canceled)

15. The server of claim 13 wherein the information is an electronic business card.

16. The server of claim 13 wherein the information is a document.

17. The server of claim 13 wherein the information is a command.

18. A mobile device comprising:
a gps receiver determining a current location of the mobile device;
a compass determining a current orientation of the mobile device;
a user interface for permitting a user to indicate information to be sent to a desired receiving device;
wherein the mobile device is programmed to send to a remote server the current location of the mobile device, the orientation of the mobile device and the user indication of the information to be sent to the desired receiving device, such that the user can select the desired receiving device by pointing the mobile device at the desired receiving device and request that the information be sent to the desired receiving device for controlling at least one electrical device.

19. The mobile device of claim 18 wherein the mobile device transmits the information from the mobile device to the remote server over a network.

20. The mobile device of claim 19 wherein the information is a command or a digital document.

21. The mobile device of claim 18 wherein the receiving device includes an electrical outlet is connected via a power cord to the at least one electrical device.

22. The method of claim 1 further comprising the step of calibrating the location of the receiving device by receiving the location from the mobile device.

23. The method of claim 1 further including the step of receiving the location and pointing direction of the mobile device over a network, wherein the location of the mobile device is a gps location.
